(19) United States
(12) Patent Application Publication
(10) Pub. No.: US 2024/0130406 A1
(43) Pub. Date: Apr. 25, 2024

(54) Method of Making a Flavored Banana Pudding

(71) Applicant: Kimberlyn Pettway, Irving, TX (US)

(72) Inventor: Kimberlyn Pettway, Irving, TX (US)

(21) Appl. No.: 17/973,400

(22) Filed: Oct. 24, 2022

(51) Int. Cl. A23L 9/10

(52) U.S. Cl. CPC A23L 9/10

(57) ABSTRACT

A quantity of whipped topping, at least one quantity of instant pudding powder, a first quantity of vanilla wafers, a second quantity of vanilla wafers, and a quantity of sliced bananas are used as the main ingredients in a method to make the flavored banana pudding. First, the at least one quantity of instant pudding powder (caramel, vanilla, pumpkin spice, red velvet, white chocolate, and/or banana cream) is mixed into the quantity of whipped topping in order to form a flavored pudding mixture. Then, the flavored pudding mixture is cooled for a specific period of time in order to form a cooled pudding mixture. Once the cooled pudding mixture is completed, the first quantity of vanilla wafers, the quantity of sliced bananas, and the second quantity of vanilla wafers can be selectively layered onto each other and the cooled pudding mixture in order to create the flavored banana pudding.

The current application is a continuation-in-part (CIP) application of a U.S. non-provisional application Ser. No. 17/408,313 filed on Aug. 20, 2021. The U.S. non-provisional application Ser. No. 17/408,313 claims a priority to a U.S. provisional application Ser. No. 63/068,283 filed on Aug. 20, 2020.

### FIELD OF THE INVENTION

The present invention relates generally to food and desserts. More specifically, the present invention is a method of making flavored banana pudding.

### BACKGROUND OF THE INVENTION

Banana pudding is a dessert item generally consisting of layers of custard, cookies (e.g., Vanilla Wafers or ladyfingers) and sliced bananas, commonly topped with whipped cream. It is commonly prepared using a baked or refrigerated method. A typical method for making Banana pudding is to repeatedly layer the bananas, custard, and wafers into a dish and top with whipped cream or meringue. However, banana pudding is generally prepared with vanilla flavor and does not expand into additional flavors, toppings, or edible ingredients such as chocolates and candies.

It is therefore an objective of the present invention introduces a method of making flavored banana pudding. More specifically, the present invention provides improvements to standard banana pudding recipe, through the introduction of a variety of additional flavors and ingredients. The present invention introduces other flavors such as caramel, chocolate, pumpkin spice, red velvet, vanilla bean, white chocolate, and other variations to provide different flavor profiles for the banana pudding. Furthermore, the present invention introduces edible ingredients such as walnuts, almonds, toffee bites, baking truffles, morsels, and other flavor enhancements into the banana pudding.

### BRIEF DESCRIPTION OF THE DRAWINGS

FIG. 1 is a schematic view showing the overall method of making the flavored banana pudding.

FIG. 2 is a schematic view showing the process of making the caramel banana pudding within the overall process of the present invention.

FIG. 3 is a schematic view showing the process of making the classic banana pudding within the overall process of the present invention.

FIG. 4 is a schematic view showing the process of making the German chocolate banana pudding within the overall process of the present invention.

FIG. 5 is a schematic view showing the process of making the pumpkin spice banana pudding within the overall process of the present invention.

FIG. 6 is a schematic view showing the process of making the pumpkin spice deluxe banana pudding within the overall process of the present invention.

FIG. 7 is a schematic view showing the process of making the red velvet banana pudding within the overall process of the present invention.

FIG. 8 is a schematic view showing the process of making the vanilla bean banana pudding within the overall process of the present invention.

FIG. 9 is a schematic view showing the process of making the classic walnut deluxe banana pudding within the overall process of the present invention.

FIG. 10 is a schematic view showing the process of making the white chocolate deluxe banana pudding within the overall process of the present invention.

### DETAIL DESCRIPTIONS OF THE INVENTION

All illustrations of the drawings are for the purpose of describing selected versions of the present invention and are not intended to limit the scope of the present invention.

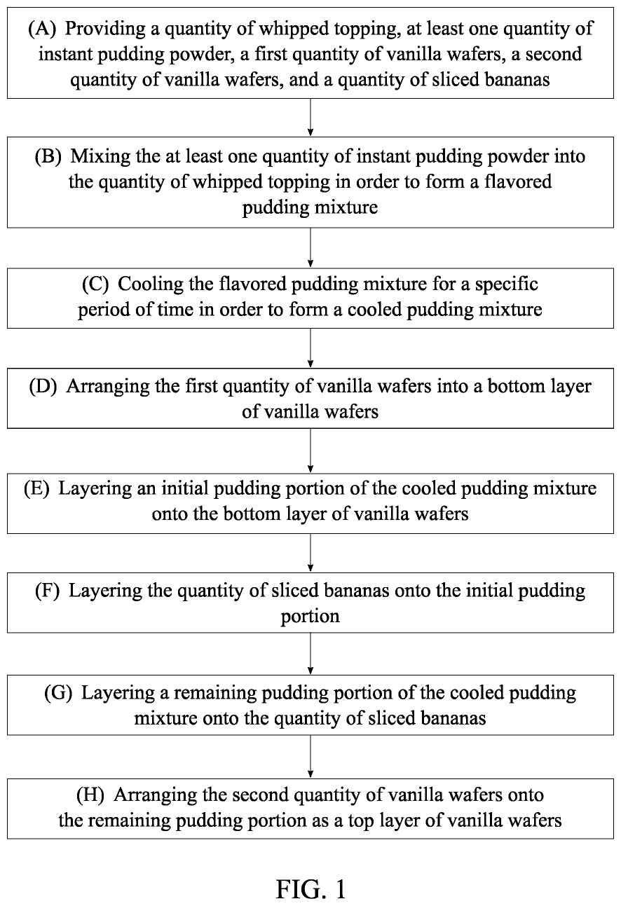

The present invention is a method of making flavored banana pudding so that the consumers can be presented with variety of flavor profiles. In reference to FIG. 1, the method for the present invention is implemented through a quantity of whipped topping, at least one quantity of instant pudding powder, a first quantity of vanilla wafers, a second quantity of vanilla wafers, and a quantity of sliced bananas (Step A). The quantity of whipped topping provides a whipped and fluffy texture for the present invention. Preferably, the present invention utilizes a defrosted whipped topping that can maintain its consistency and chilled temperature. The at least one quantity of instant pudding powder functions as the flavoring agent for the whipped topping and converts the whipped topping into a pudding mixture. Due to the powdered consistency of the at least one quantity of instant pudding powder, the pudding mixture can be prepared within 15-30 minutes thus expediting the overall process. The first quantity of vanilla wafers, the second quantity of vanilla wafers, and the quantity of sliced bananas provide flavored and textured elements to the present invention so that the consumers can bite into a flavored crunchy component and a flavored soft component. The quantity of sliced bananas enhances the banana flavor element of the present invention and allows the consumers to bite into a soft textured component.

The overall process for the method of the present invention includes the following steps that are implemented with the quantity of whipped topping, the at least one quantity of instant pudding powder, the first quantity of vanilla wafers, the second quantity of vanilla wafers, and the quantity of sliced bananas. In reference to FIG. 1, the method begins by mixing the at least one quantity of instant pudding powder into the quantity of whipped topping in order to form a flavored pudding mixture (Step B). It is important that the at least one quantity of instant pudding powder is added to the quantity of whipped topping and not the other way around to prevent developing lumps. Once the at least one quantity of instant pudding powder is fully mixed into the quantity of whipped topping, the flavored pudding mixture is cooled for a specific period of time in order to form a cooled pudding mixture (Step C). Preferably, the flavored pudding mixture is placed within a refrigerator until the cooled pudding mixture reaches the desired texture. The specific period of time generally ranges from 1-4 hours, wherein the exact time changes in reference to additional ingredients that may be added during the process. after the cooled pudding mixture is completed, a final banana pudding structure can be assembled into a container or any other type of rigid vessel that can withstand the weight of the final banana pudding structure. More specifically, the first quantity of vanilla wafers is arranged into a bottom layer of vanilla wafers of the container (Step D). Then, an initial pudding portion of the cooled pudding mixture is layered onto the bottom layer of vanilla wafers so that the bottom layer of vanilla wafers can be fully covered (Step E). Then, the quantity of sliced bananas is layered onto the initial pudding portion thus providing a layer of slice bananas on top of the initial pudding portion (Step F). Then, a remaining pudding portion of the cooled pudding mixture is layered onto the quantity of sliced bananas so that the quantity of sliced bananas can be fully covered (Step G). Then, the second quantity of vanilla wafers is layered onto the remaining pudding portion as a top layer of vanilla wafers (Step H).

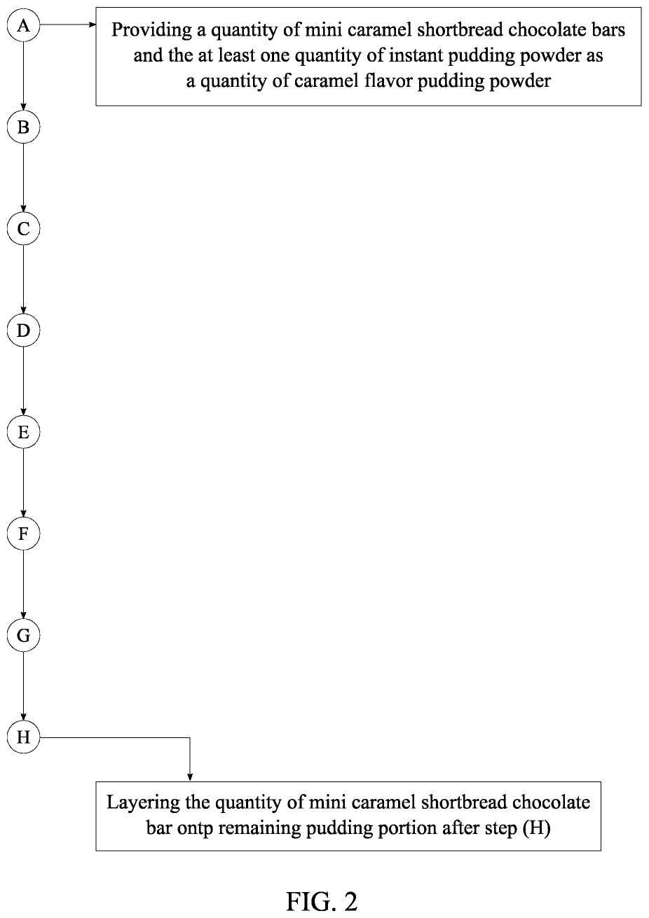

In reference to FIG. 1 and FIG. 2, the overall process can be modified to achieve a caramel flavored banana pudding. More specifically, the at least one quantity of instant pudding powder is a quantity of caramel flavor pudding powder so that the caramel flavoring can be introduced into the present invention during Step B. Furthermore, a quantity of mini caramel shortbread chocolate bars is layered onto the remaining pudding portion after (H) to enhance the caramel flavor and the appearance. Preferably, a single mini caramel shortbread chocolate bar is added on to the top layer of vanilla wafers. In order to achieve a desired consistency, the quantity of whipped topping is approximately 78% by weight (wt. %) of the cooled pudding mixture, the quantity of caramel flavor pudding powder is approximately 17 wt. % of the cooled pudding mixture, and the quantity of caramel shortbread chocolate bar is approximately 5 wt. % of the cooled pudding mixture are utilized within the caramel flavored banana pudding. In reference to the aforementioned compositional proportions, the term “approximately” preferably means within an error range of up to ±0.5 wt. %.

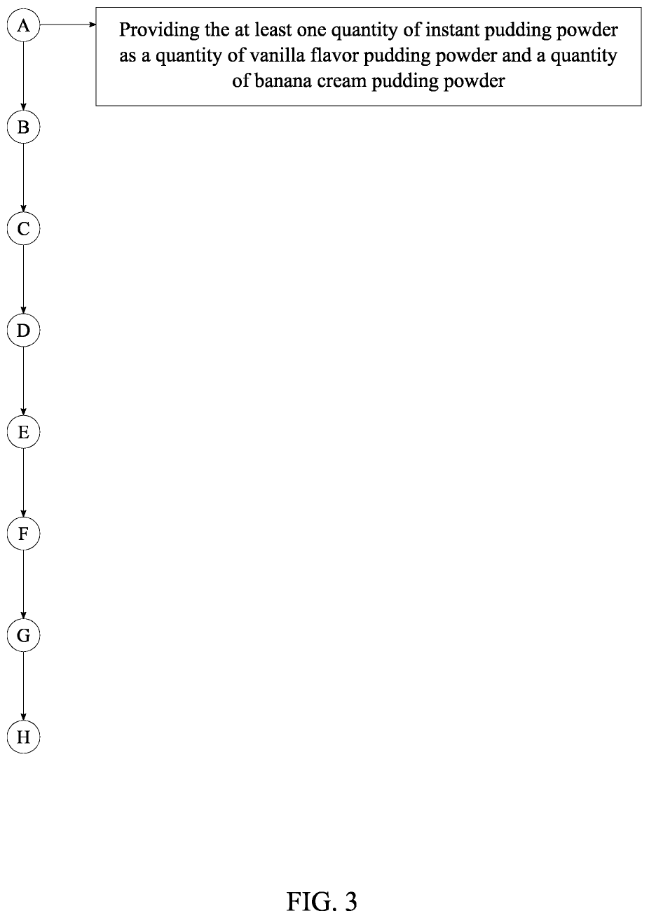

In reference to FIG. 1 and FIG. 3, the overall process can be modified to achieve a vanilla and banana cream (also known classic) flavored banana pudding. More specifically, the at least one quantity of instant pudding powder is a quantity of vanilla flavor pudding powder and a quantity of banana cream pudding powder so that the vanilla and banana cream flavorings can be introduced into the present invention during Step B. In order to achieve a desired consistency, the quantity of whipped topping is approximately 76 wt. % of the cooled pudding mixture, the quantity of vanilla flavor pudding powder is approximately 12 wt. % of the cooled pudding mixture, and the quantity of banana cream pudding powder is approximately 12 wt. % of the cooled pudding mixture are utilized within the vanilla and banana cream flavored banana pudding. In reference to the aforementioned compositional proportions, the term “approximately” preferably means within an error range of up to ±0.5 wt. %.

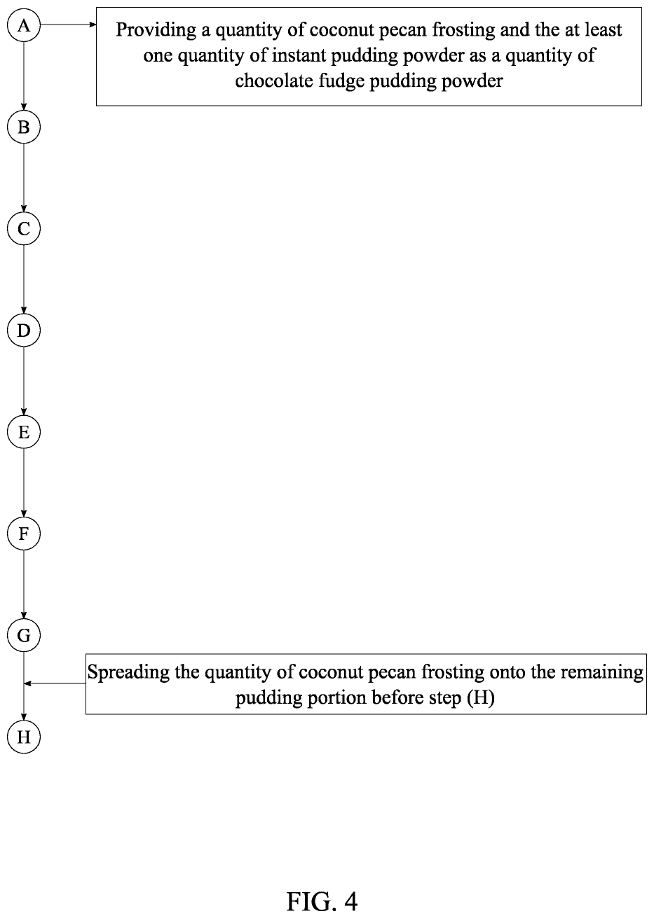

In reference to FIG. 1 and FIG. 4, the overall process can be modified to achieve a German chocolate flavored banana pudding. More specifically, the at least one quantity of instant pudding powder is a quantity of chocolate fudge pudding powder so that the chocolate flavoring can be introduced into the present invention during Step B. Furthermore, a quantity of coconut pecan frosting is layered onto present invention to enhance the chocolate flavor, the pudding texture, and the appearance. More specifically, the quantity of coconut pecan frosting is spread onto the remaining pudding portion after Step G. In order to achieve a desired consistency, wherein the quantity of whipped topping is approximately 80 wt. % of the cooled pudding mixture and the quantity of chocolate fudge pudding powder is approximately 20 wt. % of the cooled pudding mixture are utilized within the German chocolate flavored banana pudding. In reference to the aforementioned compositional proportions, the term “approximately” preferably means within an error range of up to ±0.5 wt. %.

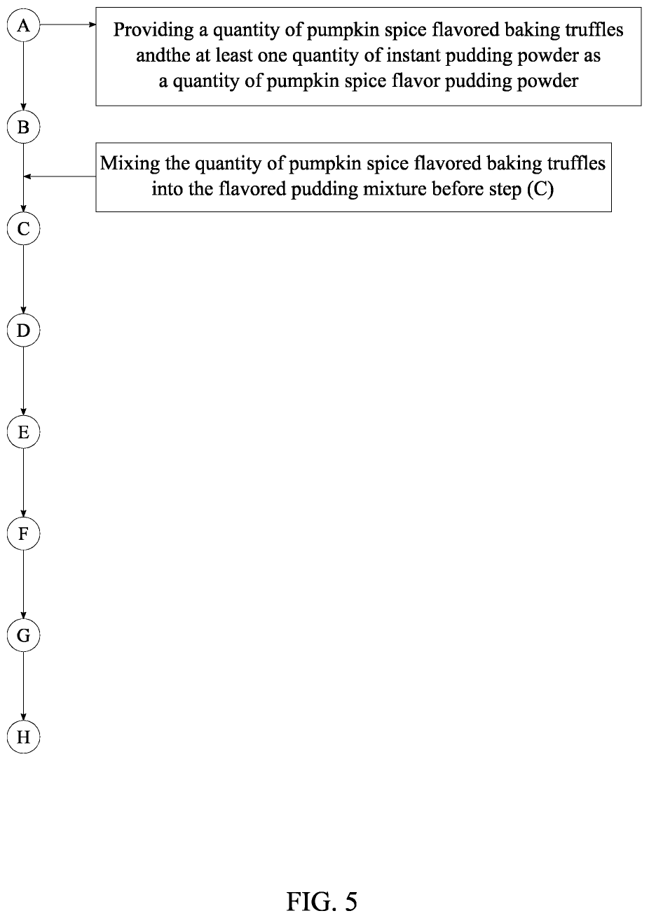

In reference to FIG. 1 and FIG. 5, the overall process can be modified to achieve a pumpkin spice flavored banana pudding. More specifically, the at least one quantity of instant pudding powder is a quantity of pumpkin spice flavor pudding powder so that the pumpkin spice flavoring can be introduced into the present invention during Step B. Furthermore, a quantity of pumpkin spice flavored baking truffles is mixed into the flavored pudding mixture before Step C to enhance the pumpkin spice flavor and the pudding texture. In order to achieve a desired consistency, the quantity of whipped topping is approximately 78 wt. % of the cooled pudding mixture, the quantity of pumpkin spice flavor pudding powder is approximately 17 wt. % of the cooled pudding mixture, and the quantity of pumpkin spice flavored baking truffles is approximately 5 wt. % of the cooled pudding mixture are utilized within the pumpkin spice flavored banana pudding. In reference to the aforementioned compositional proportions, the term “approximately” preferably means within an error range of up to ±0.5 wt. %.

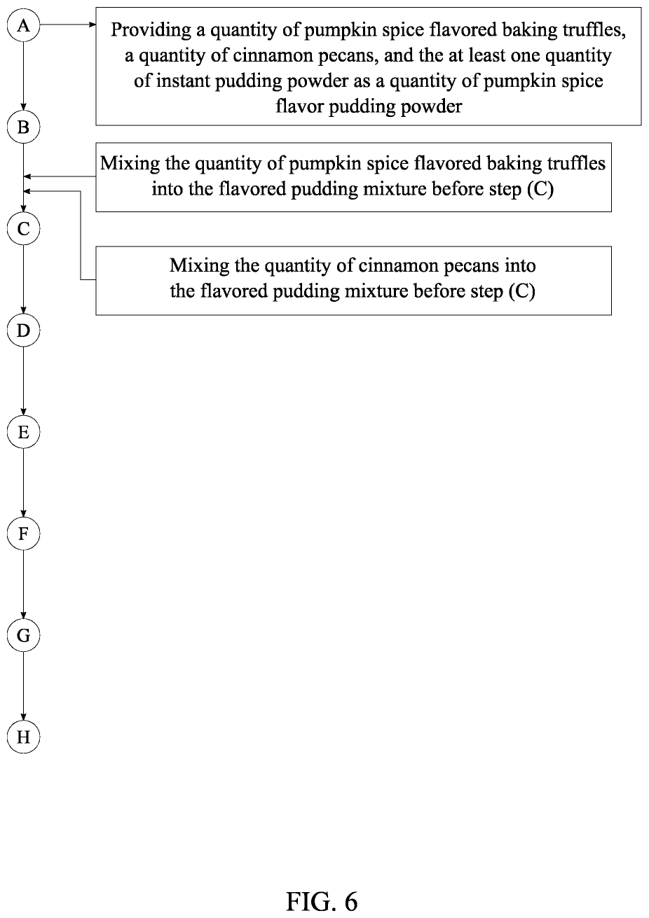

In reference to FIG. 1 and FIG. 6, the overall process can be modified to achieve an additional pumpkin spice (also known as pumpkin spice deluxe) flavored banana pudding. More specifically, the at least one quantity of instant pudding powder is a quantity of pumpkin spice flavor pudding powder so that the pumpkin spice flavoring can be introduced into the present invention during Step B. Furthermore, a quantity of pumpkin spice flavored baking truffles and a quantity of cinnamon pecans are mixed into the flavored pudding mixture before Step C to further enhance the pumpkin spice flavor and the pudding texture. In order to achieve a desired consistency, the quantity of whipped topping is approximately 75 wt. % of the cooled pudding mixture, the quantity of pumpkin spice flavor pudding powder is approximately 16 wt. % of the cooled pudding mixture, the quantity of pumpkin spice flavored baking truffles is approximately 4.5 wt. % of the cooled pudding mixture, and the quantity of cinnamon pecans is approximately 4.5% wt. % of the cooled pudding mixture are utilized within the pumpkin spice deluxe flavored banana pudding. In reference to the aforementioned compositional proportions, the term “approximately” preferably means within an error range of up to ±0.5 wt. %.

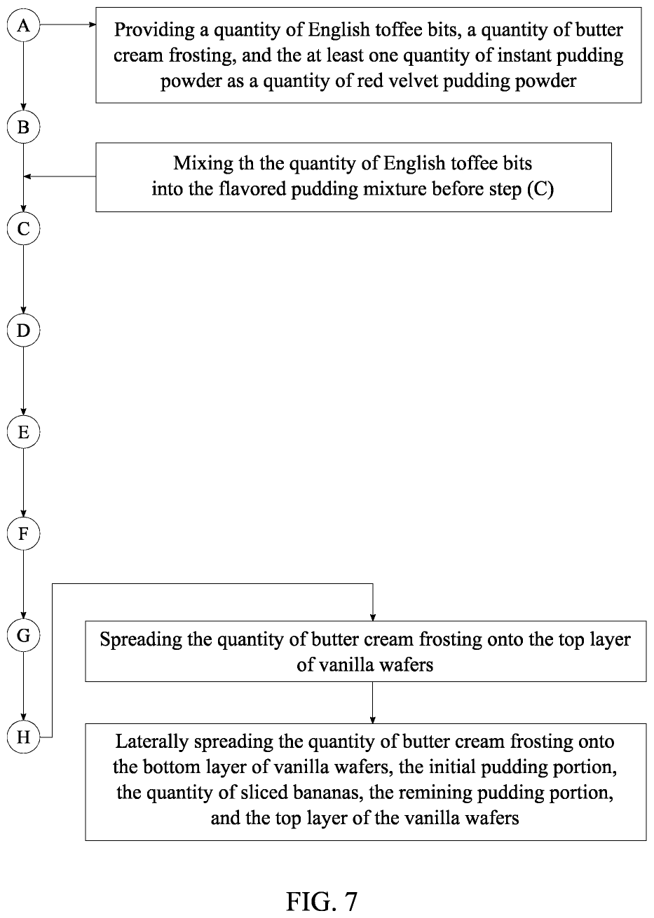

In reference to FIG. 1 and FIG. 7, the overall process can be modified to achieve a red velvet flavored banana pudding. More specifically, the at least one quantity of instant pudding powder is a quantity of red velvet pudding powder so that the red velvet flavoring can be introduced into the present invention during Step B. Furthermore, a quantity of English toffee bits is mixed into the flavored pudding mixture before Step C to enhance the flavor profile and the pudding texture. Furthermore, a quantity of butter cream frosting is layered onto present invention to enhance the flavor, the pudding texture, and the appearance. More specifically, the quantity of butter cream frosting is spread onto the top layer of vanilla wafers after Step H. The quantity of butter cream frosting is also laterally spread onto the bottom layer of vanilla wafers, the initial pudding portion, the quantity of sliced bananas, the remaining pudding portion, and the top layer of the vanilla wafers after Step H to fully cover the final banana pudding structure. In order to achieve a desired consistency, the quantity of whipped topping is approximately 75 wt. % of the cooled pudding mixture, the quantity of red velvet pudding powder is approximately 16 wt. % of the cooled pudding mixture, and the quantity of English toffee bits is approximately 9 wt. % of the cooled pudding mixture are utilized within the red velvet flavored banana pudding. In reference to the aforementioned compositional proportions, the term “approximately” preferably means within an error range of up to ±0.5 wt. %.

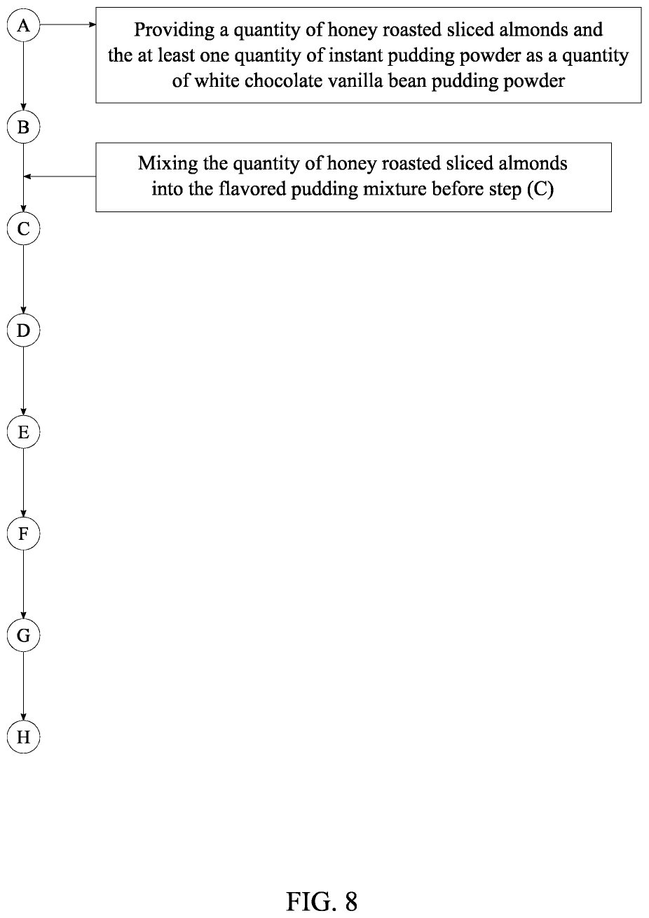

In reference to FIG. 1 and FIG. 8, the overall process can be modified to achieve a vanilla bean flavored banana pudding. More specifically, the at least one quantity of instant pudding powder is a quantity of white chocolate vanilla bean pudding powder so that the vanilla bean flavoring can be introduced into the present invention during Step B. Furthermore, a quantity of honey roasted sliced almonds is mixed into the flavored pudding mixture before Step C to enhance the flavor and the pudding texture. In order to achieve a desired consistency, the quantity of whipped topping is approximately 74 wt. % of the cooled pudding mixture, the quantity of white chocolate vanilla bean pudding powder is approximately 18 wt. % of the cooled pudding mixture, and the quantity of honey roasted sliced almonds is approximately 8 wt. % of the cooled pudding mixture are utilized within the vanilla bean flavored banana pudding. In reference to the aforementioned compositional proportions, the term “approximately” preferably means within an error range of up to ±0.5 wt. %.

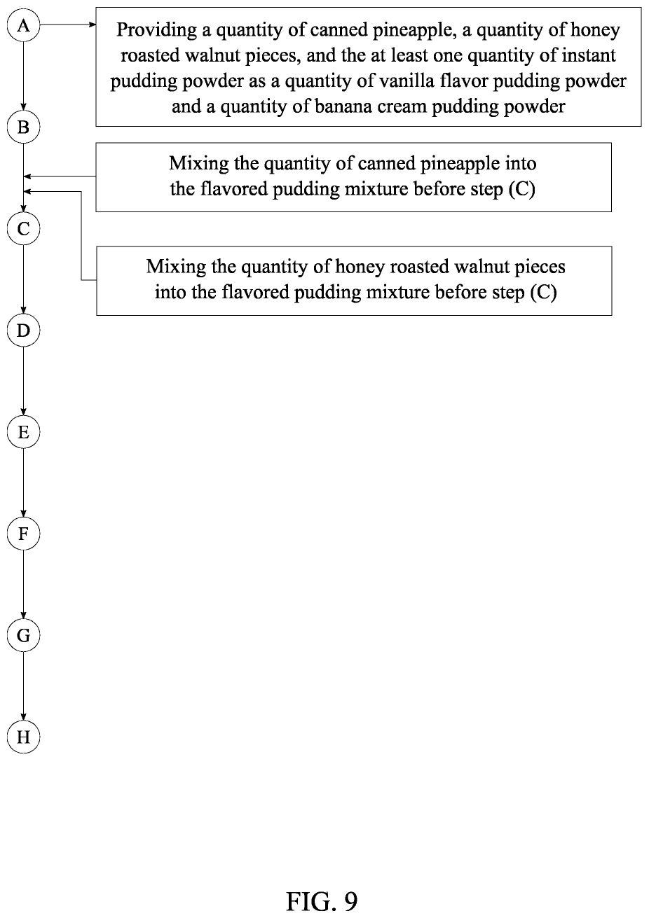

In reference to FIG. 1 and FIG. 9, the overall process can be modified to achieve a classic walnut deluxe flavored banana pudding. More specifically, the at least one quantity of instant pudding powder is a quantity of vanilla flavor pudding powder and a quantity of banana cream pudding powder so that the vanilla and banana cream flavorings can be introduced into the present invention during Step B. Furthermore, a quantity of canned pineapple and a quantity of honey roasted walnut pieces are mixed into the flavored pudding mixture before Step C to enhance the flavor and the pudding texture. In order to achieve a desired consistency, the quantity of whipped topping is approximately 36 wt. % of the cooled pudding mixture, the quantity of vanilla flavor pudding powder is approximately 5.5 wt. % of the cooled pudding mixture, the quantity of banana cream pudding powder is approximately 5.5 wt. % of the cooled pudding mixture, the quantity of canned pineapple is approximately 45 wt. % of the cooled pudding mixture, and the quantity of honey roasted walnut pieces is approximately 8 wt. % of the cooled pudding mixture are utilized within the classic walnut deluxe flavored banana pudding. In reference to the aforementioned compositional proportions, the term “approximately” preferably means within an error range of up to ±0.5 wt. %.

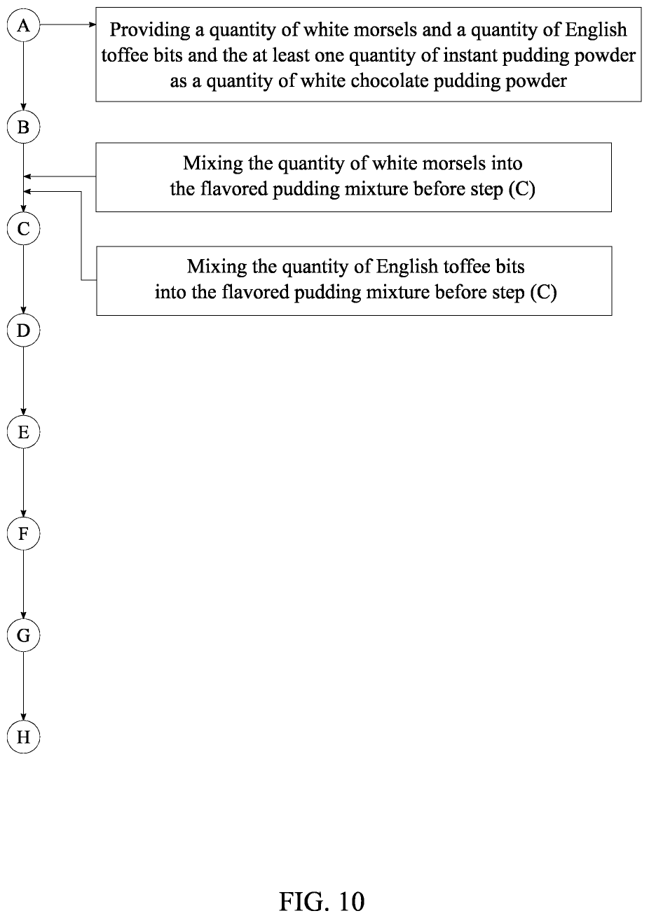

In reference to FIG. 1 and FIG. 10, the overall process can be modified to achieve a white chocolate deluxe flavored banana pudding. More specifically, the at least one quantity of instant pudding powder is a quantity of white chocolate pudding powder so that the white chocolate flavoring can be introduced into the present invention during Step B. Furthermore, a quantity of white morsels and a quantity of English toffee bits are mixed into the flavored pudding mixture before Step C to enhance the flavor and the pudding texture. In order to achieve a desired consistency, the quantity of whipped topping is approximately 75 wt. % of the cooled pudding mixture, the quantity of white chocolate pudding powder is approximately 15 wt. % of the cooled pudding mixture, the quantity of white morsels is approximately 5 wt. % of the cooled pudding mixture, and the quantity of English toffee bits is approximately 5 wt. % of the cooled pudding mixture are utilized within the white cholate deluxe flavored banana pudding. In reference to the aforementioned compositional proportions, the term “approximately” preferably means within an error range of up to ±0.5 wt. %.

Although the invention has been explained in relation to its preferred embodiment, it is to be understood that many other possible modifications and variations can be made without departing from the spirit and scope of the invention as hereinafter claimed.

What is claimed is:

1. A method of making a flavored banana pudding, the method comprising the steps of:
(A) providing a quantity of whipped topping, at least one quantity of instant pudding powder, a first quantity of vanilla wafers, a second quantity of vanilla wafers, and a quantity of sliced bananas;
(B) mixing the at least one quantity of instant pudding powder into the quantity of whipped topping in order to form a flavored pudding mixture;
(C) cooling the flavored pudding mixture for a specific period of time in order to form a cooled pudding mixture;
(D) arranging the first quantity of vanilla wafers into a bottom layer of vanilla wafers;
(E) layering an initial pudding portion of the cooled pudding mixture onto the bottom layer of vanilla wafers;
(F) layering the quantity of sliced bananas onto the initial pudding portion;
(G) layering a remaining pudding portion of the cooled pudding mixture onto the quantity of sliced bananas; and
(H) arranging the second quantity of vanilla wafers onto the remaining pudding portion as a top layer of vanilla wafers.

2. The method as claimed in claim 1 comprising the steps of:
providing a quantity of mini caramel shortbread chocolate bars;
providing the at least one quantity of instant pudding powder as a quantity of caramel flavor pudding powder; and
layering the quantity of mini caramel shortbread chocolate bars onto the remaining pudding portion after step (H).

3. The method as claimed in claim 2, wherein the quantity of whipped topping is approximately 78% by weight (wt. %) of the cooled pudding mixture, and wherein the quantity of caramel flavor pudding powder is approximately 17 wt. % of the cooled pudding mixture, and wherein the quantity of caramel shortbread chocolate bar is approximately 5 wt. % of the cooled pudding mixture.

4. The method as claimed in claim 1 comprising the step of:
providing the at least one quantity of instant pudding powder as a quantity of vanilla flavor pudding powder and a quantity of banana cream pudding powder.

5. The method as claimed in claim 4, wherein the quantity of whipped topping is approximately 76 wt. % of the cooled pudding mixture, and wherein the quantity of vanilla flavor pudding powder is approximately 12 wt. % of the cooled pudding mixture, and wherein the quantity of banana cream pudding powder is approximately 12 wt. % of the cooled pudding mixture.

6. The method as claimed in claim 1 comprising the steps of:
providing a quantity of coconut pecan frosting;
providing the at least one quantity of instant pudding powder as a quantity of chocolate fudge pudding powder; and
spreading the quantity of coconut pecan frosting onto the remaining pudding portion after step (G).

7. The method as claimed in claim 6, wherein the quantity of whipped topping is approximately 80 wt. % of the cooled pudding mixture, and wherein the quantity of chocolate fudge pudding powder is approximately 20 wt. % of the cooled pudding mixture.

8. The method as claimed in claim 1 comprising the steps of:
providing a quantity of pumpkin spice flavored baking truffles;
providing the at least one quantity of instant pudding powder as a quantity of pumpkin spice flavor pudding powder; and
mixing the quantity of pumpkin spice flavored baking truffles into the flavored pudding mixture before step (C).

9. The method as claimed in claim 8, wherein the quantity of whipped topping is approximately 78 wt. % of the cooled pudding mixture, and wherein the quantity of pumpkin spice flavor pudding powder is approximately 17 wt. % of the cooled pudding mixture, and wherein the quantity of pumpkin spice flavored baking truffles is approximately 5 wt. % of the cooled pudding mixture.

10. The method as claimed in claim 1 comprising the steps of:
providing a quantity of pumpkin spice flavored baking truffles and a quantity of cinnamon pecans;
providing the at least one quantity of instant pudding powder as a quantity of pumpkin spice flavor pudding powder;
mixing the quantity of pumpkin spice flavored baking truffles into the flavored pudding mixture before step (C); and
mixing the quantity of cinnamon pecans into the flavored pudding mixture before step (C).

11. The method as claimed in claim 10, wherein the quantity of whipped topping is approximately 75 wt. % of the cooled pudding mixture, and wherein the quantity of pumpkin spice flavor pudding powder is approximately 16 wt. % of the cooled pudding mixture, and wherein the quantity of pumpkin spice flavored baking truffles is approximately 4.5 wt. % of the cooled pudding mixture, and wherein the quantity of cinnamon pecans is approximately 4.5% wt. % of the cooled pudding mixture.

12. The method as claimed in claim 1 comprising the steps of:
providing a quantity of English toffee bits;
providing a quantity of butter cream frosting;
providing the at least one quantity of instant pudding powder as a quantity of red velvet pudding powder;
mixing the quantity of English toffee bits into the flavored pudding mixture before step (C);
spreading the quantity of butter cream frosting onto the top layer of vanilla wafers after step (H); and
laterally spreading the quantity of butter cream frosting onto the bottom layer of vanilla wafers, the initial pudding portion, the quantity of sliced bananas, the remaining pudding portion, and the top layer of the vanilla wafers after step (H).

13. The method as claimed in claim 12, wherein the quantity of whipped topping is approximately 75 wt. % of the cooled pudding mixture, and wherein the quantity of red velvet pudding powder is approximately 16 wt. % of the cooled pudding mixture, and wherein the quantity of English toffee bits is approximately 9 wt. % of the cooled pudding mixture.

14. The method as claimed in claim 1 comprising the steps of:
providing a quantity of honey roasted sliced almonds;
providing the at least one quantity of instant pudding powder as a quantity of white chocolate vanilla bean pudding powder; and
mixing the quantity of honey roasted sliced almonds into the flavored pudding mixture before step (C).

15. The method as claimed in claim 14, wherein the quantity of whipped topping is approximately 74 wt. % of the cooled pudding mixture, and wherein the quantity of white chocolate vanilla bean pudding powder is approximately 18 wt. % of the cooled pudding mixture, and wherein the quantity of honey roasted sliced almonds is approximately 8 wt. % of the cooled pudding mixture.

16. The method as claimed in claim 1 comprising the steps of:
providing a quantity of canned pineapple and a quantity of honey roasted walnut pieces;
providing the at least one quantity of instant pudding powder as a quantity of vanilla flavor pudding powder and a quantity of banana cream pudding powder;
mixing the quantity of canned pineapple into the flavored pudding mixture before step (C); and
mixing the quantity of honey roasted walnut pieces into the flavored pudding mixture before step (C).

17. The method as claimed in claim 16, wherein the quantity of whipped topping is approximately 36 wt. % of the cooled pudding mixture, and wherein the quantity of vanilla flavor pudding powder is approximately 5.5 wt. % of the cooled pudding mixture, and wherein the quantity of banana cream pudding powder is approximately 5.5 wt. % of the cooled pudding mixture, and wherein the quantity of canned pineapple is approximately 45 wt. % of the cooled pudding mixture, and wherein the quantity of honey roasted walnut pieces is approximately 8 wt. % of the cooled pudding mixture.

18. The method as claimed in claim 1 comprising the step of:
providing a quantity of white morsels and a quantity of English toffee bits;
providing the at least one quantity of instant pudding powder as a quantity of white chocolate pudding powder;
mixing the quantity of white morsels into the flavored pudding mixture before step (C); and
mixing the quantity of English toffee bits into the flavored pudding mixture before step (C).

19. The method as claimed in claim 18, wherein the quantity of whipped topping is approximately 75 wt. % of the cooled pudding mixture, and wherein the quantity of white chocolate pudding powder is approximately 15 wt. % of the cooled pudding mixture, and wherein the quantity of white morsels is approximately 5 wt. % of the cooled pudding mixture, and wherein the quantity of English toffee bits is approximately 5 wt. % of the cooled pudding mixture.
